(19) United States
(12) Patent Application Publication
(10) Pub. No.: US 2012/0089827 A1
(43) Pub. Date: Apr. 12, 2012

(54) COMPUTING DEVICE AND METHOD TO REDUCE THE TIME NEEDED FOR THE DEVICE TO START

(75) Inventors: Matthew Reynolds, London (GB); Arun Varghese, Bangalore (IN)

(73) Assignee: NOKIA CORPORATION, Espoo (FI)

(21) Appl. No.: 13/378,320

(22) PCT Filed: May 19, 2010
(86) PCT No.: PCT/IB2010/001178

§ 371 Date: Dec. 14, 2011

(30) Foreign Application Priority Data
Jun. 29, 2009 (GB) 0911236.8

(51) Int. Cl. G06F 9/00

(52) U.S. Cl. 713/2

(57) ABSTRACT

One example of the invention operates during the device shut-down procedure, to generate a merged command list containing the components from the various individual static command lists. The generated merged command list is then stored in non-volatile memory, and subsequently accessed on the next device start-up to control the launching of required software components. In this way, only one command list, being the merged command list, need be processed on device start-up, and hence device start-up time is reduced.

### TECHNICAL FIELD

Examples of the present invention relate to a computing device and associated method.

### BACKGROUND TO EXAMPLES OF THE INVENTION

When a computing device starts up it will usually need to launch various software components or run various commands. Several lists of such components or commands, referred to herein as Static Command Lists (SCLs), may be stored. On start-up these lists are processed individually, and the necessary software components launched or commands run. Processing several such lists on device start-up increases the time needed for the device to start.

### SUMMARY OF EXAMPLES OF THE INVENTION

One example of the invention operates during the device shut-down procedure, to generate a merged command list containing the required operations from the various individual static command lists. The generated merged command list is then stored in non-volatile memory, and subsequently accessed on the next device start-up to control the start-up operations performed. In this way, only one command list, being the merged command list, need be processed on device start-up, and hence device start-up time is reduced.

In one example of the invention there is provided a method, comprising: generating a merged command list defining device start-up operations to be performed on the start-up of a computing device, the generating including merging two or more existing command lists, each defining one or more start-up operations; storing the generated merged command list in non-volatile storage in the computing device; and then on device start-up, using the stored merged command list to define the device start-up operations to be performed.

In one example of the invention the generating of the merged command list is performed during a device shut-down procedure. In another example of the invention the generating of the merged command list is performed when an update of software stored on the device occurs. In a further example of the invention the generating of the merged command list is performed on command. In one example the command may be received from a user. In another example the command may be received from a network to which the device is logically connected.

In one example an indicator is stored that indicates whether the stored merged command list is valid. In this example the indicator is examined on device start-up before the stored merged command list is used to define the device start-up operations to be performed, the stored merged command list then being used if the indicator indicates that it is valid. Moreover, in this example, the indicator is re-set when a new merged command list is generated.

In a further related example then in the event that on start-up the indicator indicates that the stored merged command list is not valid, a new merged command list is generated from the two or more existing command lists, and the new merged command list is used to define the start-up operations to be performed.

Another example of the invention provides a computer program or suite of computer programs so arranged such that when executed by a computing device it/they cause the computer to operate so as to generate a merged command list defining device start-up operations to be performed on the start-up of a computing device, the generating including merging two or more existing command lists, each defining one or more start-up operations; storing the generated merged command list in non-volatile storage in the computing device; and then on device start-up, using the stored merged command list to define the device start-up operations to be performed.

A further example of the invention provides a computer readable storage medium storing the computer program or at least one of the suite of computer programs as described in the example above.

Another example of the invention provides a computing device, comprising: non-volatile data storage; and a processor; the non-volatile data storage and the processor being configured in use to cause the computing device to: i) merge two or more existing command lists, each defining one or more start-up operations so as to generate a merged command list defining device start-up operations to be performed on the start-up of a computing device; ii) store the generated merged command list in the non-volatile storage; and iii) on device start-up, use the stored merged command list to define the device start-up operations to be performed.

In one example the merged command list is generated by the device during a device shut-down procedure. In another example the merged command list is generated by the device when an update of software stored on the device occurs. In a further example the merged command list is generated by the device on command.

A further example of the invention provides a computing device having means for generating a merged command list defining starting operations to be performed when the device is started-up from two or more existing command lists; means for storing the merged command list such that it persists after device shutdown; and start-up control means that uses the merged command list to define the start-up operations that are performed when the device is started up.

### BRIEF DESCRIPTION OF THE DRAWINGS

Further features and advantages of examples of the invention will become apparent from the following description of specific embodiments of the invention, presented by way of example only, and by reference to the accompanying drawings, wherein like reference numerals refer to like parts, and wherein:—

FIG. 1 is a block diagram of a computing device according to one example of the invention;

FIG. 2 is a flow diagram illustrating the operation of a computing device according to an example of the invention;

FIG. 3 is a flow diagram illustrating the operation of a computing device according to an example of the invention;

FIG. 4 is a diagram illustrating the merging of static command lists in an example of the invention;

FIG. 5 is a block diagram of a computing device according to a second example of the invention;

FIG. 6 is a diagram illustrating a static command list in an example of the invention;

FIG. 7 is a flow diagram illustrating the operation of a computing device according to an example of the invention;

FIG. 8 is a flow diagram illustrating the operation of a computing device according to another example of the invention;

FIG. 9 is a diagram illustrating the contents of a static command list in an example of the invention; and

FIG. 10 is a flow diagram illustrating the operation of a computing device according to another example of the invention.

### DESCRIPTION OF SPECIFIC EMBODIMENTS

Various examples of the invention will now be described with respect to the accompanying figures.

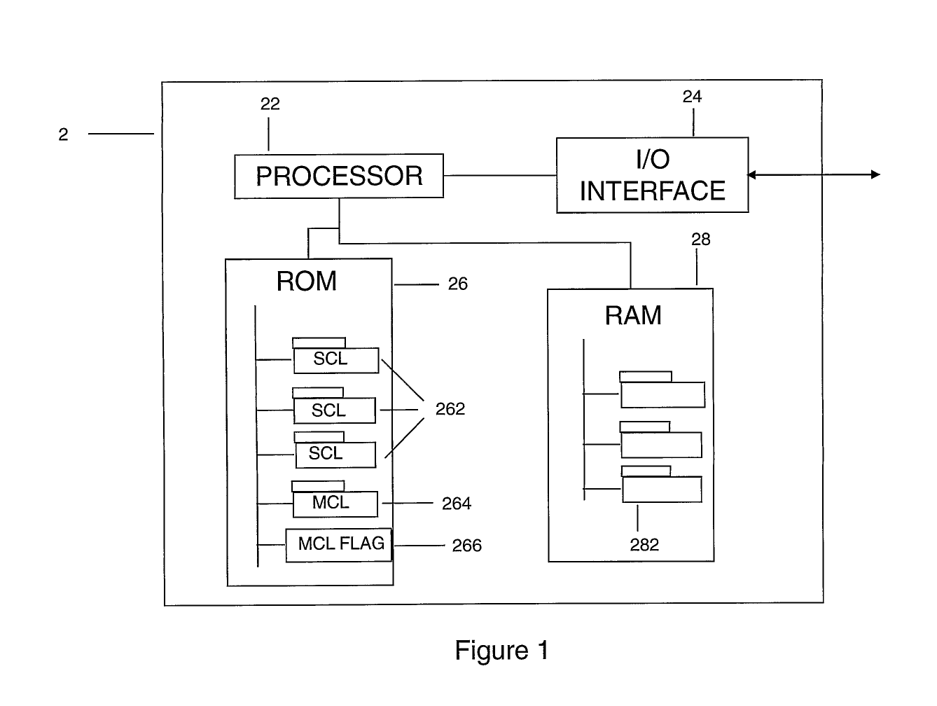

FIG. 1 is a block diagram of a typical computing device according to a first example of the invention. The computing device 2 comprises a processor 22, and has two types of memory, being read only memory 26, and random access memory 28. The read only memory 26 would typically include the device operating system, which is loaded and run by the processor 22 on device start-up. Other various software components may also be stored in ROM 26. In this example ROM 26 may be Flash memory, and hence, whilst referred to as “read-only” in fact can also be written to. However, the parts of the memory where the operating system and other essential executables and data are stored are preferably read-only.

In this example the term “computing device” should be expansively construed to include any device in which a boot or start-up routine is undertaken, and particularly although not exclusively one in which various commands are executed or software components loaded. In this respect, the computing device may be any of, for example, a desktop computer, laptop computer, netbook, mobile telephone, smartphone, digital camera, digital media player, positioning system, audio-visual equipment, set-top box, signal processing equipment, or any device with a start-up routine.

During operation of the computing device 2, the processor 22 loads various software components and data into RAM 28 as needed. Usually, software components that are presently being run are stored in RAM, although they may be kept in ROM, if the ROM is execute in place (XIP) ROM. Executables and data are provided to the processor 22 from the ROM or RAM as required, depending on the task set for the computing device by the user. The computing device 2 also includes an input and output interface 24, which the processor uses to receive user commands, and to output data in various forms, such as, for example, as audio data, as video data, or as data of other types, such as documents, spreadsheets, etc. etc. In this respect, the IO interface 24 represents in this example the various outputs and inputs available to and from the processor 22. In a practical implementation, there would typically be several such input and output interfaces of different types.

Pertinent to the present example, the ROM 26 stores several static command lists 262. Each static command list contains a list of software components that are to be launched when the computing device 2 is started up, or other commands that need to be run on start-up. In this description, the contents of an SCL, whether a command to be run or a software component to be launched will collectively be referred to as the “components” of the SCL. Usually, a start-up static command list is fixed at the ROM build time when the device is first manufactured. At device start-up, after loading the initial elements of the operating system, the processor 22 will process each static command list, and launch all the indicated software components or run the indicated commands. In the present example, multiple SCLs are stored in the ROM 26, but in other examples multiple start-up SCLs can be located on any internal fixed drive. There are no restrictions regarding the total number of start-up SCLs. On device start-up, the processor 22 processes each

SCL, and launches or runs the components indicated in each SCL. The components may have a priority assigned indicating in which order the components are to be launched or run. Alternatively, the priority of a component could be indicated by its position in the SCL list.

One problem with processing multiple SCLs on device start-up is that the device start-up time is impacted. That is, it takes longer to process multiple SCLs which may be in different places than to process a single SCL. To get around this problem, and improve device start-up time, in this example the individual SCLs are merged to produce a merged command list (MCL) which contains all of the components from the multiple start-up SCLs. There are no restrictions regarding the total number of start-up SCLs that can be used to create a merged command list. In this example, to reduce the impact of creating a merged command list at device start-up, the merged command list is created (if needed) by the processor 22 when the device shuts down. The generated merged command list is then stored in non-volatile memory, and can be accessed by the processor 22 at the next device start-up. The advantage of such operation is that device start-up times can be improved, because the processor 22 need only process components from the merged command list, and does not need to process each individual static command list.

In addition, when a static command list is updated while the device is switched on, such as by a “Firm-Ware-Over-The-Air” (FOTA) update, then in one example the merged command list is recreated on the next device shut-down, such that on device start-up, the MCL that is used to launch necessary software components is always up to date. In another example of the invention an MCL may be generated whenever a software update occurs.

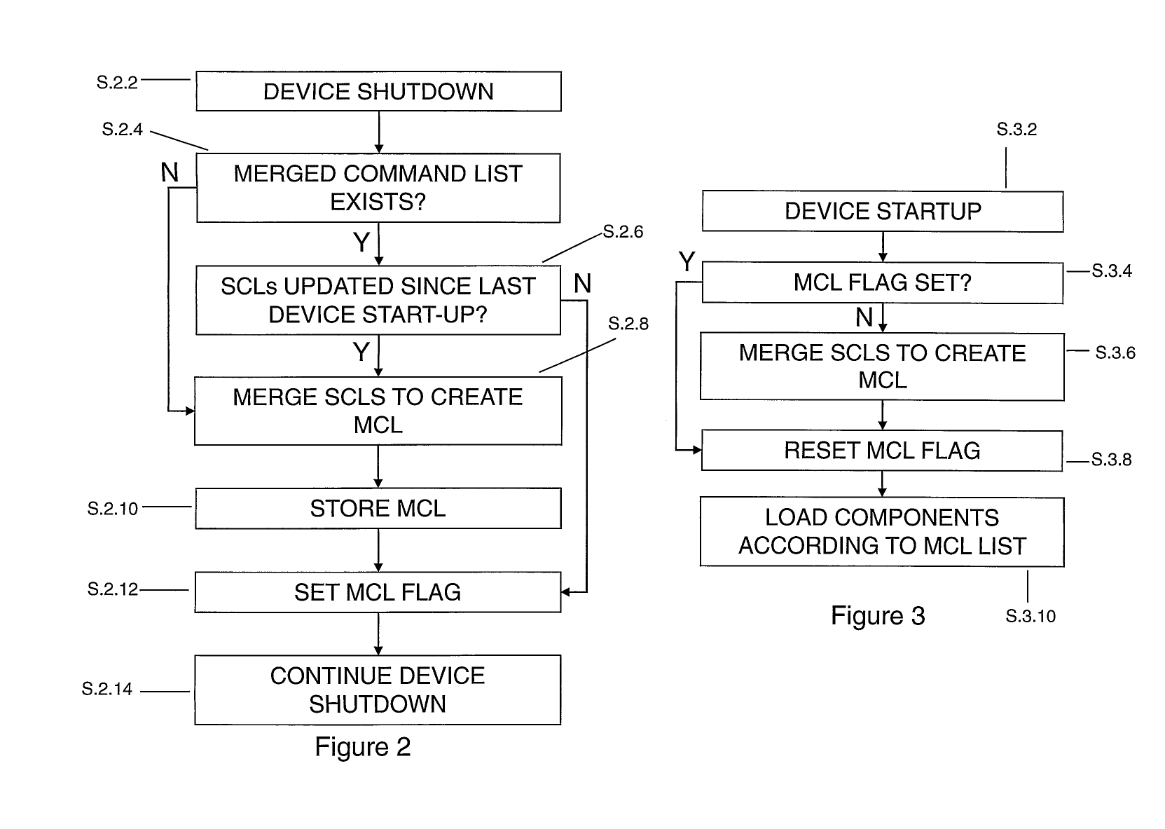

Further details of the operation of the present example will become apparent from FIGS. 2 and 3, described next.

More particularly, FIG. 2 illustrates the operation of the computing device 2 in the present example to generate a merged command list. Firstly, at step 2.2 the processor 22 determines that the device is to shut-down. Here, shut-down is intended to be a “graceful” shut-down, i.e. a controlled shut-down either commanded by the user, or by the device itself, for example because battery power is becoming low. In this respect, FIG. 2 does not apply when an accidental incident shut-down takes place, such as is the case when power is suddenly removed from the computing device 2, whether accidentally or intentionally. For example, where the computing device 2 is a portable computing device, if the battery falls out then power will be instantly removed, and the device will immediately shut-down.

Therefore, when a graceful shut-down has been commanded at step 2.2, in order to produce the merged command list the following steps are undertaken. It will be understood that other steps are also undertaken during a graceful device shut-down, but that herein we describe only those steps that pertain to the present example of the invention.

At step 2.4 an evaluation is undertaken as to whether a merged command list already exists. For example, a merged command list may have been generated by a previous device shut-down procedure. If no such merged command list exists, which may be the case where the merged command list has been deleted, or where this is the first graceful shut-down of the device, then it is necessary to create a merged command list, and processing proceeds to step 2.8. Alternatively, where a merged command list already exists, then processing proceeds to step 2.6, wherein a further evaluation is undertaken to determine whether any of the static command lists present in the device have been updated since the last device start-up.

The static command lists may be updated in several ways. For example, the static command list may be updated by a “Firmware-Over-The-Air” update, wherein the device firmware is updated automatically by receiving updated firmware over a communications link. Alternatively, the static command list may have been updated by a user loading new software onto the computing device 2. In a further example, the static command list may have been updated via an automatic update of the software on the device. For example, the operating system may be automatically updated from time to time, by the computing device automatically contacting an update server to see if updates exist. Alternatively, an update server may push updated software to the device, for example when the device is connected to a communications network. There are thus several mechanisms by which the static command list may be altered during the device operation.

If at step 2.6 it is determined that no update has been performed of any of the static command lists since the last device start-up, then there is no need to create another merged command list. In this case, processing proceeds to step 2.12, wherein a “MCL_valid” flag 266, stored with the already existing merged command list 264 is set, to indicate that the merged command list is valid. Thereafter, the device continues shutting down at step 2.14. In such a case the existing MCL will be used at the next device start-up, as the MCL_valid flag indicates that the existing MCL is already up-to-date.

Returning to step 2.6, however, if it is determined that any of the static command lists in the device have been updated since the last device start-up, then it will be necessary to recreate the merged command list that already exists, and in this case processing proceeds to step 2.8.

At step 2.8 a new merged command list is generated, by merging together the various commands in the individual static command lists stored on the device. The static command lists may be stored on any fixed drive in the device, and hence at step 2.8 the individual static command lists are accessed in turn, and the components therein copied into a single merged command list file. Various further examples of the different ways in which the static command list commands may be merged together to create the merged command list will be described later. Once the merged command list has been generated, it is then stored at step 2.10. In this example, the merged command list is stored in the ROM 26. Processing then proceeds to step 2.12, wherein the “MCL_valid” flag is set, to indicate that the newly generated merged command list is valid, and up to date. The MCL_valid flag is used by the device on device start-up, to check whether the MCL is up to date.

In this respect, as mentioned previously in this example ROM 26 is typically flash memory, such as NAND Flash Memory and has a part of the flash memory that is protected, and that cannot be written over. This part will typically store the operating system code. However, another part of the flash memory is writable, and it is in this part that the SCLs 262, and any generated MCL and MCL_valid flag 266 is stored.

FIG. 3 illustrates how the generated MCL is used at device start-up, in the present example. At step 3.2 the device begins its start-up procedure. This would typically include loading elements of the operating system from the read-only part of ROM 26, so as to enable the device to begin operating. As part of the device start-up procedure, the following steps are undertaken. It will be understood that many other steps will also be undertaken during the device start-up procedure, but which are not pertinent to the present example of the invention.

At step 3.4 the processor 22 examines whether the MCL_valid flag has been set. This is to determine whether a valid MCL, that reflects the contents of the present SCLs stored on the device has been generated. If such an MCL has been generated, then the device can access the MCL, and process the MCL to launch various software components, rather than process the individual SCLs. That is, if, at step 3.4, it is determined that the MCL_valid flag has been correctly set, then the processor 22 knows that it can trust the existing MCL to be up to date. In this case processing proceeds to step 3.8, wherein the MCL_valid flag is reset to show that it has been read, but that the MCL is still up to date, and then processing proceeds to step 3.10, wherein software components and commands are executed according to the existing MCL list. As noted previously, processing the stored MCL is quicker than processing various separate SCLs, which may be stored on different drives.

Returning to step 3.4, if the MCL_valid flag has not been correctly set, then processing proceeds to step 3.6. In this case, as there is no valid MCL already stored, the device 2 proceeds to generate an MCL during the start-up procedure. Here, during the device start-up procedure the various SCLs are accessed, and the commands therein merged together to produce a single merged command list. The merging of the SCLs at step 3.6 is the same as described previously with respect to step 2.8, and further examples of the SCL merging procedures that may be used will be given later. Once an MCL has been generated, then the MCL_valid flag is set at step 3.8, and then components are run according to the generated MCL list at step 3.10. In this case, however, the device start-up time is considerably longer, as there is the extra step of having to generate the MCL from the individual SCLs.

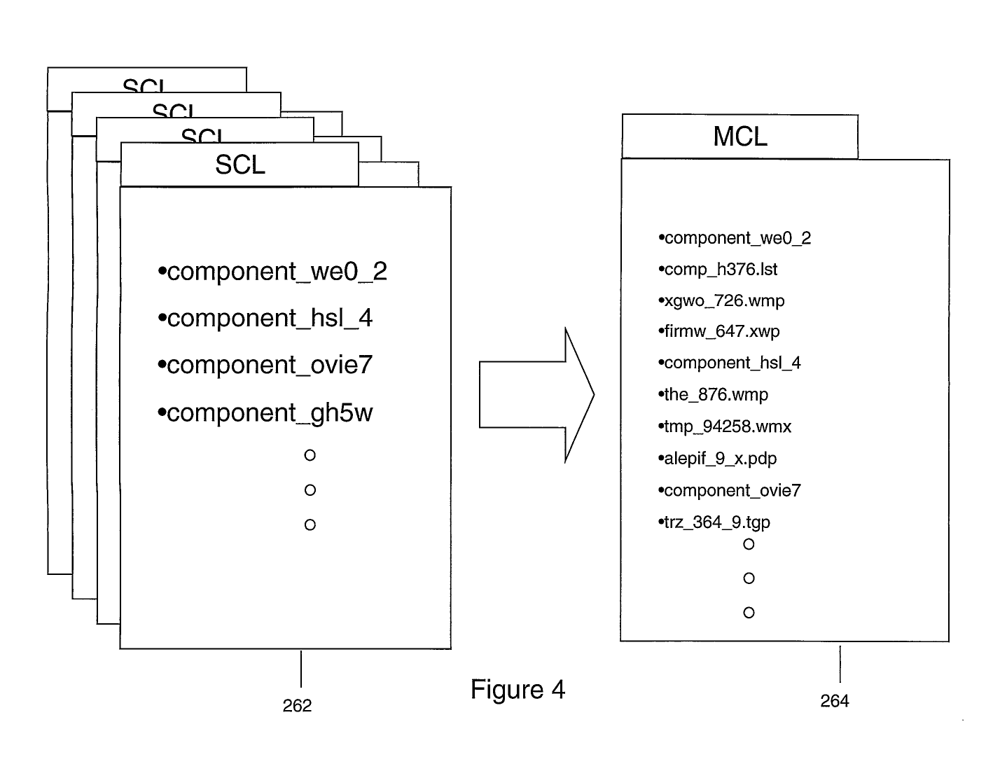

FIG. 4 illustrates an example of how multiple SCLs may be merged together into a single MCL. In this case, there are four SCLs 262, which are merged together into a single example MCL 264. As one example of how the SCLs may be merged together, in this example the SCLs are each accessed in turn, and the first command or software component in each SCL list is copied into the MCL list. Next, the second component from each SCL is taken and copied into the MCL. Then, the third component from each SCL is taken and copied into the MCL, and so on, until all SCL components have been copied into the MCL. In this example, therefore, it can be seen that the first three commands of the SCL 262 shown appear at the first, fifth, and ninth positions in the MCL list, with commands or components from the other SCLs interspersed between. It should be noted that this is but one example of how the SCL commands can be merged together, and further examples will be given later.

In this example the procedures of FIGS. 2 and 3 are implemented as software modules within the operating system. That is, separate software components are implemented within the operating system that when executed result in the operations of FIGS. 2 and 3. As noted, the operating system is typically stored in the ROM 26, as shown as nodule 268 in FIG. 2, and the software components implementing FIGS. 2 and 3 are contained therein.

In this first example, therefore, the computing device 2 generates a merged command list from individual static command lists, and then processes the merged command list on device start-up, so as to launch software components as required. As noted previously, the processing of the merged command list rather than the separate static command lists results in a quicker device start-up.

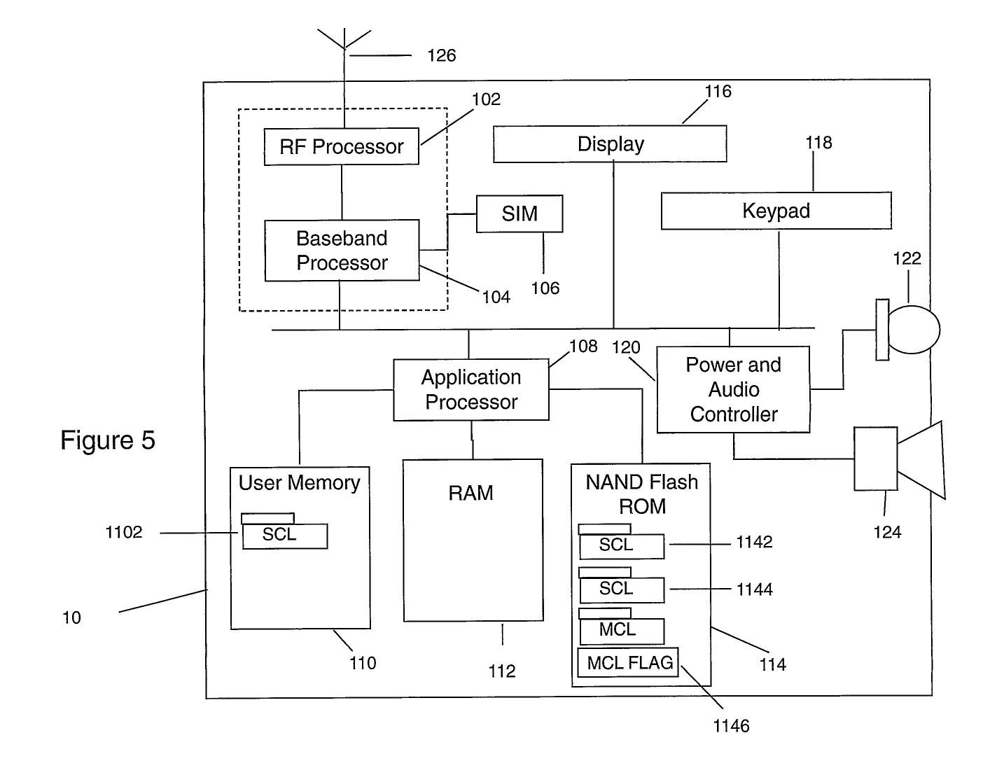

Another example of the invention will now be described with respect to FIG. 5. In this example the computing device is a smart phone 10 comprising hardware to perform the telephony functions, together with an application processor in corresponding support hardware to enable the phone to have other functions which are desired by a smart phone, such as messaging, calendar, word processing functions, and the like. In FIG. 5 the telephony hardware is represented by the RF processor 102 which provides an RF signal to antenna 126 for the transmission of telephony signals, and the receipt therefrom. Additionally provided is baseband processor 104, which provides signals to and receives signals from the RF processor 102. The baseband processor 104 also interacts with a subscriber identity module 106, as is well known in the art.

Also provided in this example is a display 116, and a keypad 118. These are controlled by an application processor 108, which is often a separate integrated circuit from the baseband processor 104 and RF processor 102, although in the future it is anticipated that single chip solutions will become available. A power and audio controller 120 is provided to supply power from a battery (not shown) to the telephony subsystem, the application processor, and the other hardware. Additionally, the power and audio controller 120 also controls input from a microphone 122, and audio output via a speaker 124.

In order for the application processor 108 to operate, various different types of memory are often provided. Firstly, the application processor 108 may be provided with some random access memory (RAM) 112, into which data and program code can be written and read from at will. Code placed anywhere in RAM can be executed by the application processor 108 from the RAM.

Additionally provided is separate user memory 110, which is used to store user data, such as user application programs (typically higher layer application programs which determine the functionality of the device), as well as user data files, and the like.

In order for the application processor 108 to operate, an operating system is provided, which is started as soon as the smart phone system 10 is first switched on. The operating system code is commonly stored in a read only memory, and in modern devices the read only memory is often NAND flash ROM 114. The ROM will store the necessary operating system components in order for the device 10 to operate, but other software programs might also be stored, such as application programs, and the like, and in particular those application programs which are mandatory to the device, such as, in the case of a smart phone, communications applications and the like. In addition, as shown in FIG. 5, the smart phone 10 in the present embodiment also stores various Static Command Lists (SCLs) 1142 in the NAND flash ROM 114,as well as a generated Merged Command List (MCL) 1144, and the MCL_valid flag 1146. An SCL 1102 is also stored in user memory 110. The generation of the MCL 1144 from the various SCLs 1142 and 1102 in the present example embodiment will be described further below.

In the present example the smart phone 10 generally operates in the same manner as the computing device 2 of the previously described example. That is, the smart phone 10 can operate in accordance with FIGS. 2 and 3 as previously described, in order to generate and use merged command lists, from multiple static command lists. However, in another example, the smart phone 10 may not operate generally in accordance with FIG. 3 on device start-up, and in particular need not perform step 3.6 to generate a merged command list in the case that the MCL_valid flag is not set at step 3.4. Instead, where the MCL_valid flag is not set, the smart phone 10 may simply start-up by accessing the individual static command lists separately, and processing each SCL separately. Then, when the smart phone 10 shuts down, and the procedure of FIG. 2 is performed, an MCL will be generated at that time, which can then be used during a subsequent start-up procedure.

Generally, therefore, smart phone 10 of the present example operates in accordance with FIG. 2, to generate a merged command list when the smart phone 10 is shut-down. The generated merged command list is then stored, and accessed at next device start-up, and used in place of the individual static command lists. In this respect, the operation of smart phone 10 is generally the same as the computing device of the previous example.

Also similarly to the previous example, smartphone 10 has its O/S stored in NAND Flash ROM 114, as shown in FIG. 5. The procedure of FIG. 2 is, in this example, implemented as a software component that is part of the operating system, stored on the NAND Flash ROM.

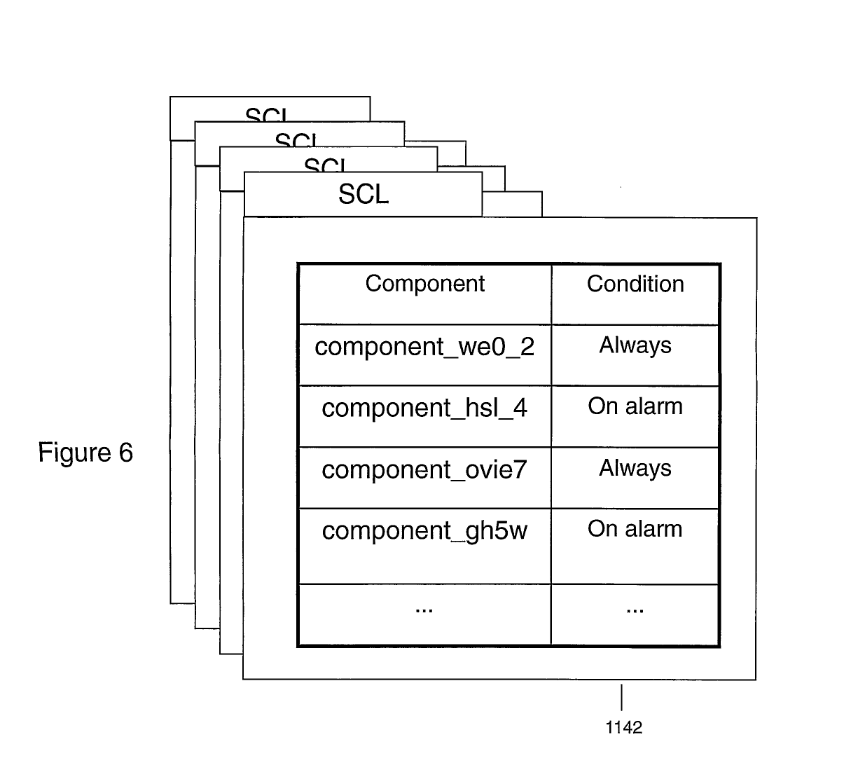

However, in the present example, smart phone 10 can perform additional actions in generating a merged command list from the individual static command lists. FIG. 6 gives an example of an enhanced static command list, wherein each component or command in the static command list also has an associated condition associated with it. The condition indicates a particular condition which may occur during device start-up, as to whether the individual component or command in the static command list should be launched or run as appropriate. For example, one command or component in a static command list may have the condition “always” which means that it should always be run on each start-up. Other commands or components may have a condition associated with them that they should only be launched or run when the device performs a start-up in response to a particular condition. One such condition is an “alarm” condition. For example, the user of the smart phone 10 may have placed the device into a sleep mode, but set an alarm to wake the device up at a particular time. In this case, during the start-up procedure based on an alarm condition, different components may be launched, or different commands performed, than during a normal device start-up. In the present example, when such conditions are contained within an SCL, then those conditions are maintained when an SCL component is copied into an MCL during its generation.

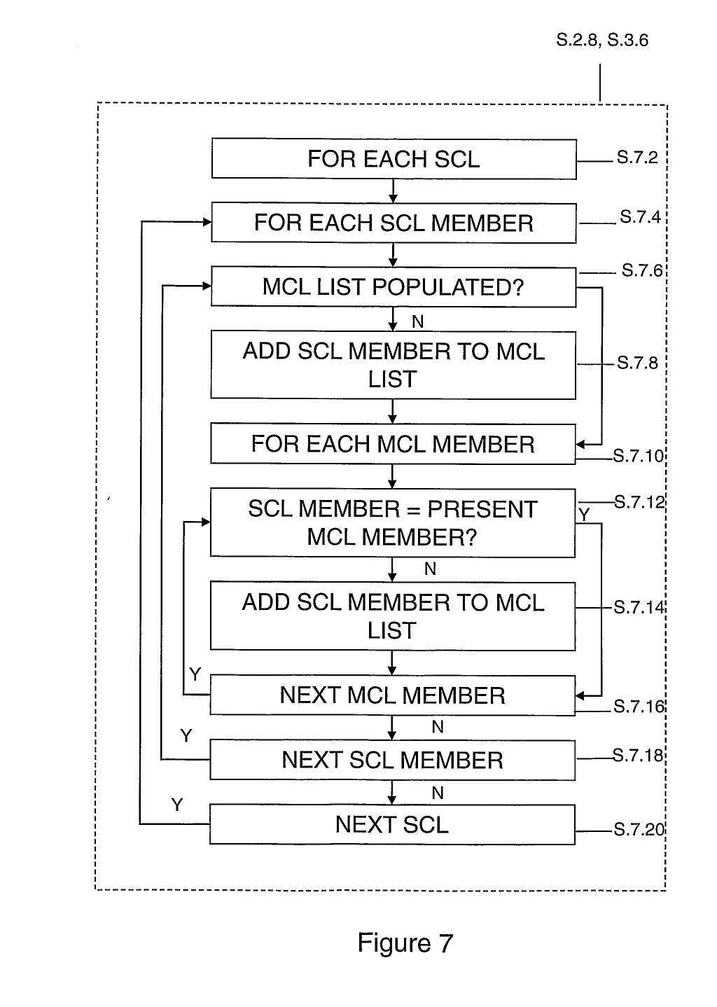

Turning now to FIG. 7, there will be described in more detail an example SCL merging process, that may be used for example in step 2.8 or step 3.6 of FIGS. 2 and 3 described previously. It should be understood that this is one example of how the SCL merge process may operate. Other examples will be described later.

Generally, the procedure as set out in FIG. 7 acts to access each SCL in turn, and then, for each command or component in the SCL, a check is performed as to whether that command or component has been added to a merged command list that is being generated, and if it has not been so added, then the command or component is added to the list. However, if the command or component already exists in the list in identical form, then it is not added to the MCL list. This therefore prevents unnecessary multiple instances of the same command being performed, or software component being launched.

In more detail, at step 7.2 a FOR processing loop is started to process each SCL in turn. For example, in the smart phone 10, the SCL 1102 and the two SCLs 1142 would be processed in turn. Next, at step 7.4 a further FOR processing loop is started to process each component member of the present SCL that is presently being processed by the outer processing loop.

Within these nested processing loops, firstly, at step 7.6 an evaluation is performed as to whether the MCL that is presently being generated in fact has any members. This evaluation will return false only for the first iteration of the processing loops, as thereafter a command or component will have been added to the MCL that is being generated. If the MCL list is not populated, then at step 7.8 the present SCL command or component member that is presently being processed is added to the MCL list that is being generated. Conversely, if this is not the first iteration of the process, then the MCL list will be populated, and processing will proceed to step 7.10.

At step 7.10 a further nested processing loop is started, to process each member of the MCL that is presently being generated. Then, at step 7.12 an evaluation is undertaken to determine whether the present SCL member component that is being processed is the same as the present MCL member component that is being processed. If it is not the same, then the present SCL member component is added to the MCL list, at step 7.14. If it is the same, then it means that the present SCL component that is being processed has already been added to the MCL list, and hence does not need to be added again. In this case, processing proceeds to step 7.16. Likewise, from step 7.14 processing also proceeds to step 7.16.

At step 7.16 an evaluation is undertaken as to whether there is a next MCL number to process. If this is the case, then the next MCL member is selected, and processing proceeds back to step 7.12. If it is not the case, then all presently existing MCL member commands or components have been looked at with respect to the SCL member that is presently being processed, and hence processing proceeds to step 7.18. In this case, the next SCL member of the SCL that is presently being processed is selected, where one exists, and processing proceeds back to step 7.6. Conversely, once each member of the SCL that is presently being processed has been looked at, then step 7.18 will allow the procedure to proceed to step 7.20, wherein the next SCL to be processed is selected. Processing then reverts back to step 7.4.

Therefore, as described, this procedure looks at each SCL in turn, and copies each SCL member into the MCL, unless the SCL member component has already been included in the MCL.

Within the above example, where an SCL command or component member has conditions attached to it, for example as described previously with respect to FIG. 6, then those conditions are also copied into the MCL.

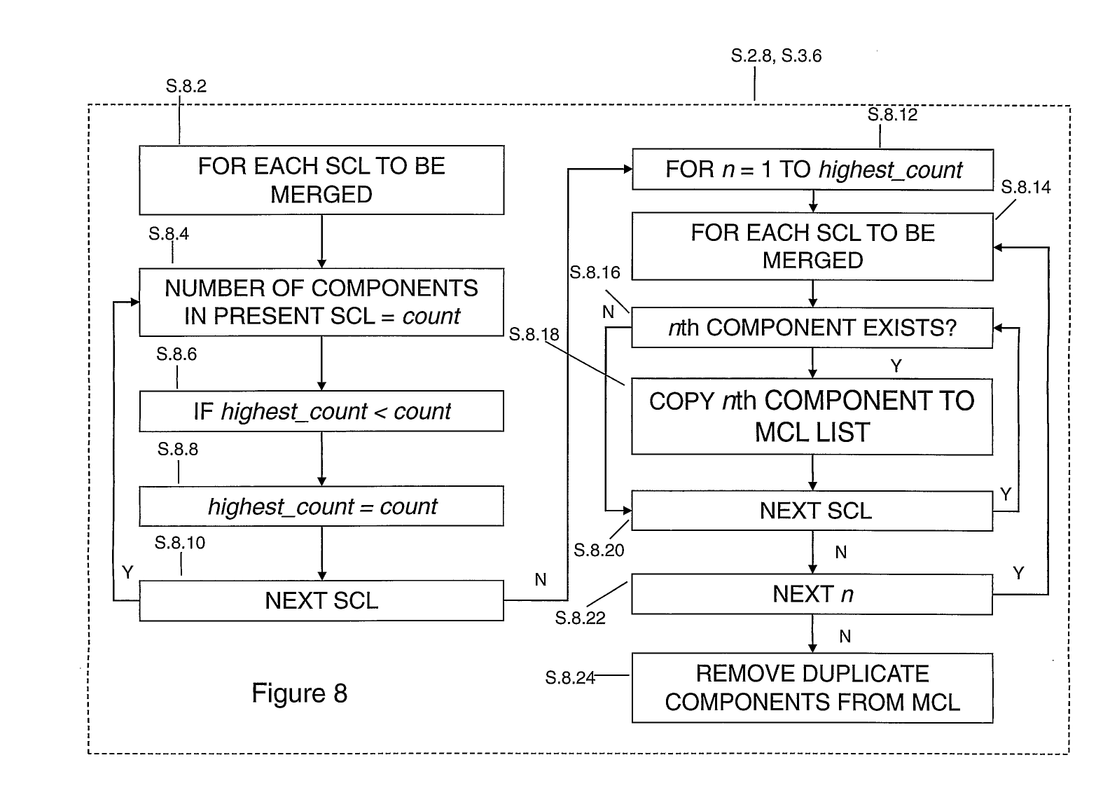

A further example of how SCLs may be merged will next be described with respect to FIG. 8. Again, the procedure to be described with respect to FIG. 8 can be used in the MCL generation steps in FIGS. 2 and 3, described previously.

In the previous example, SCL components were copied into the MCL in the order in which they appeared in the SCL, but because each SCL is processed completely one after the other, the components of one SCL which is processed after another SCL will appear in the MCL list after the components of the SCL that was processed first. As an alternative, in the present example, the first component from each SCL to be merged is included first in the MCL list, and then the second component of each SCL is included after all of the first components. Thus, all the first components of each SCL are positioned higher in the MCL list than second components. Similarly, second components of each SCL are positioned higher in the MCL list than third components, and so on. Thus, where position in an SCL list indicates priority in terms of which command or component should be executed or run first, then this priority can be maintained in the MCL.

In order to achieve such an outcome, firstly in the procedure of FIG. 8 processing is undertaken to determine the SCL with the highest number of components. This is necessary so that the procedure knows how many iterations need to be performed. Therefore, at step 8.2, a processing loop is started to process each SCL that is to be merged together into an MCL. At step 8.4 the number of components in the present

SCL is determined, and is assigned to a variable “count”. Next, at steps 8.6 and 8.8 an evaluation is performed to determine whether a variable “highest_count” is less than the variable count, and if it is, then the variable highest_count is set to be equal to the variable count. This procedure is performed for every SCL, and at the end of it the variable highest_count should contain a count of the number of components in the SCL with the most components therein.

Thereafter, at steps 8.12 to 8.24, the MCL is generated by taking each first component in turn from each SCL and copying into the MCL, followed by each second component, followed by each third component, and so on. In particular, at step 8.12 a processing loop is started based on a variable n, and is performed a number of times, incrementing n between 1 and the “highest_count” variable previously mentioned. Within the outer loop, at step 8.14 a second nested processing loop is started to process each SCL for the present variable n. Within this nested loop at step 8.16 an evaluation is performed as to whether the nth component exists in the present SCL, and if it does then the nth component is copied to the MCL list at step 8.18. These two loops then cycle round via the evaluations at step 8.20 and 8.22. Thereafter, each SCL component will have been copied into the MCL component list. However, the MCL component list may contain duplicate entries from the various SCLs, and hence at step 8.24 these duplicate entries are removed from the MCL. Typically, the duplicate entries lower in the list are removed, such that the highest place entry is retained.

Using the example merged process of FIG. 8, MCLs such as described previously with respect to FIG. 4 may be obtained.

In addition, in another example step 8.24 need not be performed. In this case, the MCL may contain duplicate entries, but depending on the specific application this may be acceptable.

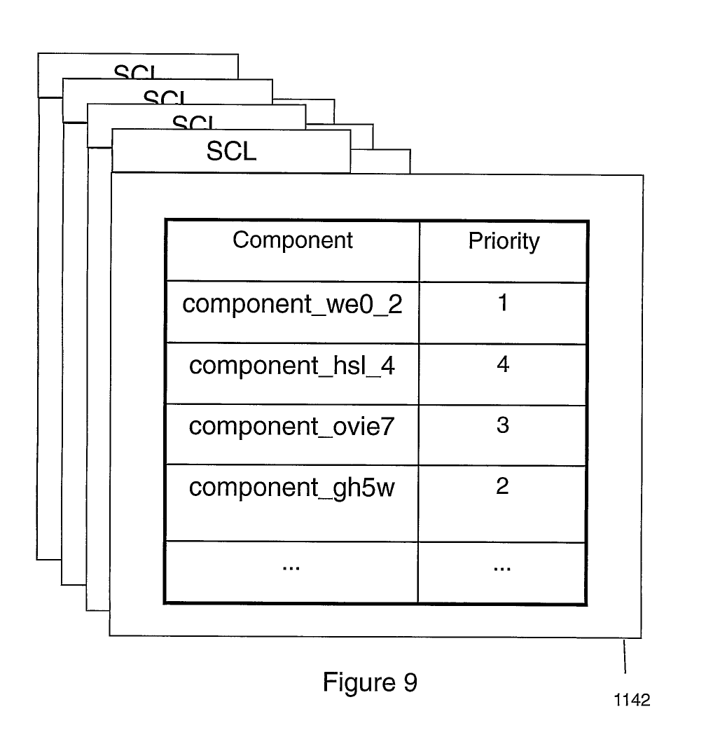

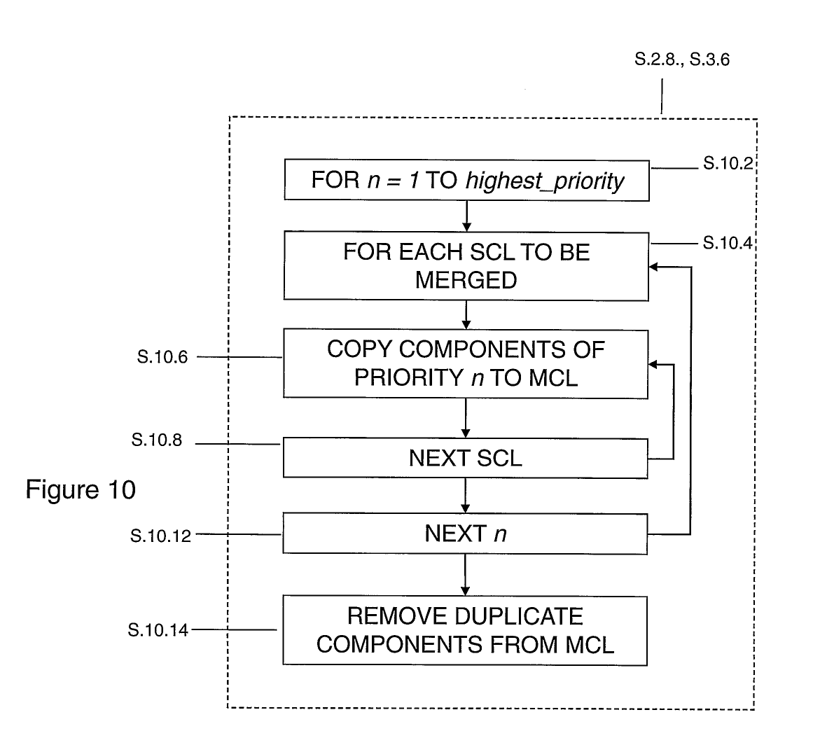

Another example of how the merge process may be undertaken will now be described with respect to FIGS. 9 and 10.

In FIG. 9, the SCL 1142 stores priority information for each command or component in its list. The priority information indicates the order in which the commands or components should be run. In this case, the commands or components may be in any order in the static command list, with the attendant priority information then indicating to the device the order in which commands should be run on start-up.

In another example merged process, therefore, this priority information may be used to determine the order in which components are copied to the MCL. FIG. 10 illustrates an example procedure which makes use of this priority information to merge SCLs together. Again, as with the previous examples of merge procedures, the merge procedure of FIG. 10 may be used as the merge step in steps 2.8 or 3.6 of FIGS. 2 and 3, described previously. The procedure of FIG. 10 generally acts to look at each SCL, and copy higher priority components of each SCL into the MCL before lower priority components. That is, each component of priority 1 will be copied from each SCL before components of priority 2 from each SCL, and so on.

The merge procedure operates in this example as follows. Firstly, at step 10.2 a processing loop is started to process each priority type. That is, components of priority 1 are processed first, followed by components of priority 2, up to the highest priority number in the SCLs. In this respect, reference to “highest_priority” is potentially misleading, as in fact a component with a priority of value “highest_priority” will in fact be the lowest priority component. In this case, the “highest_priority” variable is a numerical value.

Next, a further processing loop is started at step 10.4, to process each SCL in turn. Thereafter, at step 10.6 the components of present priority n are copied into the MCL. These processing loops continue via steps 10.8 and 10.12 such that each SCL is looked at, and each priority is looked at. The result is an MCL wherein the SCL components of the highest priority are copied first, followed by SCL components of the next highest priority, and so on. At step 10.14 the MCL is examined further and duplicate components are removed therefrom, if necessary. However, in other examples, this step may not be performed.

There are thus numerous ways in which the static command lists can be merged together to perform a merged command list. Other examples will be apparent to the intended reader, and examples of the invention are not limited to any of the specific examples set out herein.

In addition, in the examples described above, the generation of the merged command list is performed preferably at device shut-down, or alternatively may be performed at device start-up, if no valid MCL is available. Typically, MCL generation at start-up may be performed on the very first device start-up. In other examples, MCL generation can be undertaken at any time during the operation of the device. For example, it need not be undertaken at device shut-down, but may be undertaken during normal device operation. In one example, MCL generation may be scheduled to be performed regularly or periodically during normal device operation. Alternatively, in another example MCL generation may be performed when the device is commanded to do so by a user. In a further example MCL generation may be performed when the device is commanded to by another device, or by a network. For example, where the device is a mobile telephone, the device may receive a command to generate an MCL from the mobile network.

In another example, MCL generation may be performed whenever new software is installed on the device, or when software already on the device is updated. In a further example MCL generation may be performed during idle periods, when the device is switched on and operating, but is not being used by a user for any particular task. For example, when the processor usage has been below a particular level, say 20%, for a period of time such as an hour, then MCL generation may be performed during such periods of low use.

In the preferred example, the generated MCL is stored in non-volatile memory, such that it persists while the device is shut-down, and is then available for use on the next device start-up.

In a further example, because the SCLs are no longer used during the device start-up, they may be written in human-readable XML or some other higher level language, or with human readable comments. This is because the time taken to parse human readable SCLs on start-up is not relevant, where a suitable MCL has been generated. Writing the SCLs in human-readable language will make it easier for device development to occur.

In addition, in another example where the SCLs are written in human-readable language, then during the merge process for such SCL components a translation from the SCL human readable component into binary equivalent is made, and the binary equivalent stored in the MCL. This allows the MCL to be read more quickly on device start-up than would be the case if the human readable XML or the like was copied directly into the MCL.

The example merge processes of FIGS. 7, 8, and 10 described above are, in the described examples, typically implemented as software components that form part of the operating system. That is, when used in the smartphone 10 of the example above described with respect to FIG. 5, the merge processes form part of the operating system stored on NAND Flash ROM 114.

Various further modifications, whether by way of addition, deletion, or substitution will be apparent to the intended reader, being a person skilled in the art, to provide further examples, any and all of which are intended to fall within the appended claims.

1. A method comprising:
merging two or more existing command lists, each command list defining one or more start-up operations, to generate a merged command list defining a computing device start-up operations to be performed on start-up of a computing device;
storing the merged command list in the computing device; and
on computing device start-up, defining computing device start-up operations to be performed, based at least in part on the stored merged command list.

2. A method according to claim 1, wherein the merged command list is generated during the computing device shut-down procedure.

3. A method according to claim 1, wherein the merged command list is generated if software stored on the computing device is updated.

4. A method according to claim 1, wherein the merged command list is generated based at least in part on a command.

5. A method according to claim 1 further comprising:
storing an indicator indicating that the stored merged command list is valid; and
examining the indicator, on the computing device start-up, before the stored merged command list is used to define the computing device start-up operations to be performed, and wherein the stored merged command list is used if the stored merged command list is valid.

6. A method according to claim 5, wherein the indicator is re-set if a new merged command list is generated.

7. A method according to claims 5 further comprising generating a new merged command list from the two or more existing command lists on start-up, if the indicator indicates that the stored merged command list is invalid, and the new merged command list is used to define the start-up operations to be performed.

8-9. (canceled)

10. A computing device comprising:
at least one memory; and
at least one processor;
the at least one memory and the at least one processor are configured in use to cause the computing device to:
merge two or more existing command lists, each defining one or more start-up operations, to generate a merged command list defining a computing device start-up operations to be performed on the start-up of the computing device;
store the generated merged command list; and
on computing device start-up, define computing device start-up operations to be performed, based at least in part on the stored merged command list.

11. A computing device according to claim 10, wherein the merged command list is generated by the computing device during the computing device shut-down procedure.

12. A computing device according to claim 10, wherein the merged command list is generated by the computing device if software stored on the computing device is updated.

13. A computing device according to claim 10, wherein the merged command list is generated based at least in part on a command.

14. A computing device according to any of claims 10 further comprising a stored indicator indicating that the stored merged command list is valid, wherein on the computing device start-up the indicator is examined before the stored merged command list is used to define the computing device start-up operations to be performed, and wherein the stored merged command list is used if the stored merged command list is valid.

15. A computing device according to claim 14, wherein the indicator is re-set if a new merged command list is generated.

16. A computing device according to claims 13, wherein the at least one memory and the at least one processor are further configured in use to cause the computing device to generate a new merged command list from the two or more existing command lists on start-up, if the indicator indicates that the stored merged command list is invalid, and the new merged command list is used to define the start-up operations to be performed.

17. A computer program product comprising at least one computer-readable storage medium, the computer-readable storage medium comprising a set of instructions configured to cause an apparatus to at least:
merge two or more existing command lists, each command list defining one or more start-up operations, to generate a merged command list defining a computing device start-up operations to be performed on start-up of a computing device;
store the merged command list in the computing device; and
on computing device start-up, define computing device start-up operations to be performed, based at least in part on the stored merged command list.

18. The computer program product of claim 17, wherein the merged command list is generated during the computing device shut-down procedure.

19. The computer program product of claim 17, wherein the merged command list is generated if software stored on the computing device is updated.

20. The computer program product of claim 17, wherein the merged command list is generated based at least in part on a command.

21. The computer program product of claim 17, wherein the set of instructions are further configured to cause the apparatus at least to:
store an indicator indicating that the stored merged command list is valid; and
examine the indicator, on the computing device start-up, before the stored merged command list is used to define the computing device start-up operations to be performed, and wherein the stored merged command list is used if the stored merged command list is valid.

22. The computer program product of claim 21, wherein the indicator is re-set if a new merged command list is generated.

23. The computer program product of claim 21, wherein the set of instructions are further configured to cause the apparatus at least to:
generate a new merged command list from the two or more existing command lists on start-up, if the indicator indicates that the stored merged command list is invalid, and the new merged command list is used to define the start-up operations to be performed.
